(19) United States
(12) Patent Application Publication
(10) Pub. No.: US 2009/0260761 A1
(43) Pub. Date: Oct. 22, 2009

(54) HEAT-ACTIVABLE ADHESIVE TAPE PARTICULARLY FOR BONDING ELECTRONIC COMPONENTS AND CONDUCTOR TRACKS

(75) Inventor: Thorsten Krawinkel, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: TESA AG, Hamburg (DE)

(21) Appl. No.: 12/439,629

(22) PCT Filed: Sep. 24, 2007
(86) PCT No.: PCT/EP2007/060084

§ 371 Date: Mar. 25, 2009

(30) Foreign Application Priority Data
Oct. 6, 2006 (DE) 10 2006 047 735.9

(51) Int. Cl. B32B 37/12; C09J 163/02

(52) U.S. Cl. 156/330; 525/418; 524/538

(57) ABSTRACT

Heat-activable adhesive tape particularly for producing and further processing electronic components and conductor tracks, with an adhesive composed at least of
a) a polyamide having terminal amino and/or acid groups,
b) an epoxy resin,
c) a compound having a long apolar chain with at least 6 carbon atoms and at least one reactive end capable of reacting with the epoxy resins,
d) if desired, a plasticizer,
the polyamide reacting with the epoxy resin at temperatures of at least 150° C., and the ratio in weight fractions of a) to b) lying between 50:50 to 99:1.

The invention relates to a heat-activable adhesive of low fluidity at high temperatures particularly for bonding flexible printed conductor tracks (flexible printed circuit boards, FPCBs).

Flexible printed circuit boards are nowadays employed in a multiplicity of electronic devices such as mobile phones, radios, computers, printers and many more. They are constructed from layers of copper and a high-melting resistant thermoplastic: mostly polyimide, less often polyester. These FPCBs are frequently produced using adhesive tapes with particularly exacting requirements. On the one hand, for producing the FPCBs, the copper foils are bonded to the polyimide sheets; on the other hand, individual FPCBs are also bonded to one another, in which case polyimide bonds to polyimide. In addition to these applications, the FPCBs are also bonded to other substrates.

The adhesive tapes used for these bonding tasks are subject to very exacting requirements. Since very high bond performances must be attained, the adhesive tapes used are generally heat-activable tapes, which are processed at high temperatures. These adhesive tapes must not emit volatile constituents in the course of this high temperature load during the bonding of the FPCBs, which often takes place at temperatures around 200° C. In order to achieve a high level of cohesion the adhesive tapes ought to crosslink during this temperature load. High pressures during the bonding operation make it necessary for the flowability of the adhesive tapes at high temperatures to be low. This is achieved by high viscosity in the uncrosslinked adhesive tape or by very rapid crosslinking. Moreover, the adhesive tapes must also be solder bath resistant, in other words must for a short time withstand a temperature load of 288° C.

For this reason the use of pure thermoplastics is not rational, despite the fact that they melt very readily, ensure effective wetting of the bond substrates and lead to very rapid bonding within a few seconds. At high temperatures, though, they are so soft that they tend to swell out of the bondline under pressure in the course of bonding. Accordingly there is no solder bath resistance either.

For crosslinkable adhesive tapes it is usual to use epoxy resins or phenolic resins, which react with specific hardeners to form polymeric networks. In this specific case the phenolic resins cannot be used, since in the course of crosslinking they generate elimination products, which are released and, in the course of curing or, at the latest, in the solder bath, lead to blistering.

Epoxy resins are employed primarily in structural adhesive bonding and, after curing with appropriate crosslinkers, produce very brittle adhesives, which indeed achieve high bond strengths but possess virtually no flexibility.

Increasing the flexibility is vital for use in FPCBs. On the one hand the bond is to be made using an adhesive tape which ideally is wound onto a roll; on the other hand the conductor tracks in question are flexible, and must also be bent, readily apparent from the example of the conductor tracks in a laptop, where the foldable screen is connected via FPCBs to the further circuits.

Flexibilizing these epoxy resin adhesives is possible in two ways. First, there exist epoxy resins flexibilized with elastomer chains, but the flexibilization they experience is limited, owing to the very short elastomer chains. The other possibility is to achieve flexibilization through the addition of elastomers, which are added to the adhesive. This version has the drawback that the elastomers are not crosslinked chemically, meaning that the only elastomers that can be used are those which at high temperatures still retain a high viscosity.

Because the adhesive tapes are produced generally from solution it is frequently difficult to find elastomers of a sufficiently long-chain nature not to flow at high temperatures while being still of a sufficiently short-chain nature that they can be brought into solution. Production via a hotmelt operation is possible but very difficult in the case of crosslinking systems, since it is necessary to prevent premature crosslinking during the production operation.

Compositions of particular cohesion and high bond strength can be obtained through the use of a soluble polyamide which is crosslinked with epoxy resins. A drawback is that polyamides tend to absorb water, which on the one hand can have an adverse effect with regard to bonding, if the water absorbed evaporates again and bubbles form in the bond. On the other hand, the water absorption alters the electrical properties of the adhesive: the strong insulator effect subsides.

Crosslinkable adhesives based on polyamide or derivatives thereof have been described.

The polyamides in question, as in U.S. Pat. No. 5,885,723 A or JP 10 183 074 A or JP 10 183 073 A, are modified polyamides which preferably contain polycarbonate groups or polyalkylene glycol groups. These polyamides are reacted so that they contain epoxide end groups and, as a result, can be crosslinked with the epoxides by means of a hardener.

Otherwise disclosed are adhesives with polyamideimides of very specific composition, in U.S. Pat. No. 6,121,553 A, for example.

It is an object of the invention, therefore, to provide an adhesive tape which is heat-activable, crosslinks in the heat, possesses a low viscosity in the heat, displays effective adhesion to polyimide, in the uncrosslinked state is soluble in organic solvents and has only a low water absorbency.

This object is achieved, surprisingly, by means of an adhesive tape as characterized in more detail in the main claim. The dependent claims provide advantageous developments of the subject-matter of the invention and also possibilities for its use.

A heat-activable adhesive particularly for producing and further processing electronic components and conductor tracks, with an adhesive composed at least of
a) a polyamide having terminal amino and/or acid groups,
b) an epoxy resin,
c) a compound having a long apolar chain with at least 6 carbon atoms and at least one reactive end capable of reacting with the epoxy resins,
   the polyamide reacting with the epoxy resin at temperatures of at least 150° C., and the ratio in weight fractions of a) to b) lying between 50:50 to 99:1.

The general expression “adhesive tape” for the purposes of this invention embraces all sheetlike structures, such as two-dimensionally extended sheets or sheet sections, tapes with extended length and limited width, tape sections, diecuts and the like.

The ratio in weight fractions of a) to b) lies preferably between 70:30 to 95:5.

The polyamides used in the adhesives of the invention ought to have not too high a molecular weight (preferably a weight-average molecular weight M_{w} of less than 40 000) and ought to have been flexibilized and/or only partly crystalline or not crystalline at all. This is necessary on the one hand for the described flexibility of the adhesives; on the other hand, the raw materials are processed preferably from solution, and completely crystalline polyamides are difficult to dissolve, and can be dissolved only in inconvenient solvents such as trifluoroacetic acid or sulphuric acid.

Consequently, according to one advantageous development of the invention, copolymers are used instead of the homopolymers such as PA 6,6. To flexibilize the PA 6,6 it can be copolymerized with PA 6. Other copolymers, such as PA 6,6/6,12 or PA 6,6/6,11, for example, can likewise be employed. Reducing the molecular weight raises the solubility of the polyamides. The molecular weight ought not to be lower to a point where the good mechanical properties are lost.

The weight-average molecular weight M_{w} ought to be greater than 500 g/mol.

In order to lower the crystallinity further it is also possible to use terpolymers. Not only purely aliphatic polyamides can be employed, but also aliphatic-aromatic polyamides. Preference is given to those which have a long aliphatic chain or ideally, as a result of copolymerization, have aliphatic chains which differ in length. An improvement in solubility here can also be accomplished by the use of aromatics having meta and/or ortho substitution. The use of isophthalic acid in place of terephthalic acid lowers the crystallinity considerably. In order to lower the crystallinity in aliphatic-aromatic polyamides it is also possible to employ monomers of the following formula:

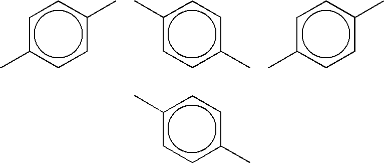

In these formulae X can be oxygen, nitrogen or sulphur, but may also be an alkylene group having at least one carbon atom. An isopropylene group is also possible.

Likewise possible are extensions to these structures through substituents in the aromatics, or a prolongation of the structure by means of further aromatic groups.

Further examples of amines which can be used in accordance with the invention are given in U.S. Pat. No. 6,121,553 A.

Polyesteramides as well can be used, subject to the proviso that they are soluble in a solvent that is suitable for application to a backing.

For the synthesis of the polyamide it is important that either the amino component(s) or the acid component(s) are used in excess, so that on the one hand the molecular weight does not become too high and on the other hand that terminal reactive groups are present which can react with the epoxy resins.

Since the polyamides are crosslinked, it is also possible to use fairly low molecular weight oligomers (specifically those having a weight-average molecular weight M_{w} of 500 to 2000 g/mol), in order to obtain sufficient strength.

Epoxy resins are usually understood to be not only monomeric but also oligomeric compounds containing more than one epoxide group per molecule. They may be reaction products of glycidyl esters or epichlorohydrin with bisphenol A or bisphenol F or mixtures of these two. Likewise suitable for use are epoxy novolak resins, obtained by reacting epichlorohydrin with the reaction product of phenols and formaldehyde. Monomeric compounds containing two or more epoxide end groups, used as diluents for epoxy resins, can also be employed. Likewise suitable for use are elastically modified epoxy resins.

Examples of epoxy resins are Araldite™ 6010, CY-281™, ECN™ 1273, ECN™ 1280, MY 720, RD-2 from Ciba Geigy, DER™ 331, 732, 736, DEN™ 432 from Dow Chemicals, Epon™ 812, 825, 826, 828, 830 etc. from Shell Chemicals, HPT™ 1071, 1079, likewise from Shell Chemicals, and Bakelite™ EPR 161, 166, 172, 191, 194 etc. from Bakelite AG.

Commercial aliphatic epoxy resins are, for example, vinylcyclohexane dioxides such as ERL-4206, 4221, 4201, 4289 or 0400 from Union Carbide Corp.

Elasticized elastomers are available from Noveon under the name Hycar.

Epoxy diluents, monomeric compounds containing two or more epoxide groups, are for example Bakelite™ EPD KR, EPD Z8, EPD HD, EPD WF, etc. from Bakelite AG or Polypox™ R 9, R12, R 15, R 19, R 20 etc. from UCCP.

In one preferred embodiment of the invention more than one epoxy resin is used simultaneously.

The high strength of the polyamides and the additional crosslinking of the epoxy resins with these polyamide hardeners means that very high strengths are achieved within the adhesive film. The bond strengths to the polyimide as well, however, are extremely high.

Ideally the epoxy resins and the polyamides are employed in a proportion such that the molar fraction of epoxide groups and amino groups and/or acid groups is just equivalent. However, the proportion between hardener groups and epoxide groups can be varied within wide ranges, although for sufficient crosslinking neither of the two groups ought to be present in a molar equivalent excess of more than ten times.

For additional crosslinking it is also possible to add chemical crosslinkers which react with the epoxy resins. Crosslinkers are not necessary for the reaction but can be added particularly for the purpose of scavenging excess epoxy resin.

As crosslinkers or hardeners the compounds primarily employed are as follows and as described in more detail in U.S. Pat. No. 3,970,608 A:
polyfunctional aliphatic amines, such as triethylenetetramine for example
polyfunctional aromatic amines, such as isophoronediamine for example
guanidines, such as dicyandiamide for example
polyhydric phenols
polyhydric alcohols
polyfunctional mercaptans
polybasic carboxylic acids
acid anhydrides with one or more anhydride groups

Although adhesive tapes based on polyamide and epoxy resin, with and without hardener, can achieve very high holding powers, the softening point of these adhesives is comparatively high, which in certain cases restricts processing. Because the adhesive tapes are laminated prior to pressing to the article that is to be bonded, a very high temperature of above 160° C. is needed. In order to lower this temperature, plasticizers are added to the adhesives in one further preferred embodiment of the invention. Tests also show that the stability after storage is much higher for plasticizers-blended polyamide-based adhesives than for those without added plasticizers. Besides the laminating temperature, it is also possible for the addition of plasticizers to lower the crosslinking temperature, and at the same time the storage stability is increased.

Suitable plasticizers first include the plasticizers typically employed in PVC.

These may be selected, for example, from the groups of the
phthalates such as DEHP (diethylhexyl phthalate), DBP (dibutyl phthalate), BBzP (butyl benzyl phthalate), DnOP (di-n-octyl phthalate), DiNP (diisononyl phthalate) and DiDP (diisodecyl phthalate)
trimellitates such as TOTM (trioctyl trimellitate), TINTM (triisononyl trimellitate)
aliphatic dicarboxylic esters such as DOM (dioctyl maleate), DOA (dioctyl adipate) and DINA (diisononyl adipate)
phosphoric esters such as TCEP (tris(2-chloroethyl)phosphate)
natural oils such as castor oil or camphor

In addition it is also possible to use the following plasticizers:
low molecular weight polyalkylene oxides, such as polyethylene oxides, polypropylene oxides and polyTHF
rosin-based tackifier resins with a low softening point, such as Abalyn or Foralyn 5040 from Eastman

Preference is given here to the last two groups, on account of their better environmental compatibility and the reduced tendency to diffuse out of the adhesive assembly. Mixtures of the individual plasticizers can be employed as well.

The fraction of the plasticizer according to one outstanding embodiment of the invention is between 5% and 45% by weight, based on the total mass of the adhesive.

To reduce the water absorbency, compounds are employed which on the one hand are able to react with the epoxy resins or with the polyimide itself, at high temperature, and on the other hand contain a very apolar group. All of these compounds must be soluble in the same solvent as the polyamide.

The apolar group is preferably a hydrocarbon chain, which can be fully saturated, although double bonds in the molecule are also possible. To achieve the reduction in water absorbency, the apolar chain must contain at least 6 C atoms.

The crosslinkable group capable of reacting with the epoxy resins or the polyamide may be, for example, an acid, acid anhydride, amino, alcohol, mercapto, nitrile, halogen or epoxide group. Also possible is the presence of two functional groups in the molecule. The apolar group may be located between these two groups.

Also suitable for use are molecules in which the functional groups come about only at the high temperature, by means of a chemical reaction.

Besides the apolar chain and the reactive group there may also be further functional and non-functional groups present in the molecule.

Examples of compounds of this kind which lower the water absorbency and contain a functional group capable of reacting with the epoxides are stearic acid, oleic acid, palmitic acid, lauric acid, dodecylamine, octylamine and dodecyl mercaptan.

Two functional groups are carried, for example, by sebacic acid, aminoundecanoic acid and diaminooctane.

The fraction of the compound containing the reactive group, according to one outstanding embodiment of the invention, is between 1% and 10% by weight, based on the total mass of the adhesive.

Besides the polyamide, the epoxy resin and the compound that reduces water absorbency, there may be further ingredients present in the adhesive.

In order to raise the reaction rate of the crosslinking reaction it is possible to use what are known as accelerators.

Examples of Possible Accelerators Include the Following
tertiary amines, such as benzyldimethylamine, dimethylaminomethylphenol and tris(dimethylaminomethyl)phenol
boron trihalide-amine complexes
substituted imidazoles
triphenylphosphine

Further additives which can be used typically include:
primary antioxidants, such as sterically hindered phenols
secondary antioxidants, such as phosphites or thioethers
in-process stabilizers, such as C-radical scavengers
light stabilizers, such as UV absorbers or sterically hindered amines
processing assistants
fillers, such as silicon dioxide, glass (ground or in the form of beads), aluminium oxides, zinc oxides, calcium carbonates, titanium dioxides, carbon blacks, metal powders, etc.
colour pigments and dyes and also optical brighteners

To produce the adhesive tape the constituents of the adhesive are dissolved in a suitable solvent, for example hot ethanol, hot methanol, N-methylpyrrolidone, dimethylformamide, dimethylacetamide, dimethyl sulphoxide, γ-butyrolactone or halogenated hydrocarbons or mixtures of these solvents, and the solution is coated onto a flexible substrate provided with a release layer, such as a release paper or release film, for example, and the coating is dried, so that the composition can be easily removed again from the substrate. Following appropriate converting, diecuts, rolls or other shapes can be produced at room temperature. Corresponding shapes are then adhered, preferably at elevated temperature, to the substrate to be bonded, polyimide for example.

It is also possible to coat the adhesive directly onto a polyimide backing. Adhesive sheets of this kind can then be used for masking copper conductor tracks for FPCBs.

It is not necessary for the bonding operation to be a one-stage process; instead, the adhesive tape can first be adhered to one of the two substrates by carrying out hot lamination. In the course of the actual hot bonding operation with the second substrate (second polyimide sheet or copper foil), the epoxide groups then fully or partly cure and the bondline attains the high bond strength.

The admixed epoxy resins and the polyamides should preferably not yet enter into any chemical reaction at the lamination temperature, but instead should react with one another only on hot bonding.

As compared with many conventional adhesives for the bonding of FPCBs, the adhesives produced have the advantage of possessing, after bonding, a very high temperature stability, so that the assembly created remains of high strength even at temperatures of more than 150° C.

An advantage of the adhesives of the invention is that the elastomer is in fact chemically crosslinked with the resin; there is no need to add a hardener for the epoxy resin, since the elastomer itself acts as hardener.

This crosslinking may take place both via terminal acid groups and via terminal amino groups. Crosslinking via both mechanisms simultaneously is also possible. In order that enough end groups are present, the molecular weight of the polyamides must not be too high, since otherwise the degree of crosslinking becomes too low. Molecular weights above 40 000 lead to products with only a little crosslinking.

The determinations of the weight-average molecular weights M_{w} were carried out by means of gel permeation chromatography (GPC). The eluent used was THF (tetrahydrofuran) containing 0.1% by volume trifluoroacetic acid. Measurement was made at 25° C. The preliminary column used was PSS-SDV, 5μ, 10³ Å, ID 8.0 mm×50 mm. Separation was carried out using the columns PSS-SDV, 5μ, 10³ and also 10⁵ and 10⁶ each with ID 8.0 mm×300 mm. The sample concentration was 4 g/l, the flow rate 1.0 ml per minute. Measurement was carried out against PMMA standards.

### EXAMPLES

The invention is described in more detail below by a number of examples, without restricting the invention in any way whatsoever.

### Example 1

90 parts of a copolyamide 6/66/136 having a viscosity number in 96% strength sulphuric acid to ISO 307 of 122 ml/g (Ultramid 1C from BASF) are dissolved with stirring in boiling ethanol (20% strength solution), and the cooled solution is admixed with 12 parts of the epoxy resin EPR 161 (Bakelite, epoxide number of 172), 20 parts of a polyethylene glycol having an average molar mass of 2000, and 3 parts of lauric acid. After the components have fully dissolved, the solution is coated out onto a siliconized backing, so that drying gives an adhesive film 25 μm thick.

### Comparative Example 2

The polyamide with the epoxy resin and the plasticizer is dissolved as in Example 1, but this time the lauric acid is omitted. Once again, an adhesive film with a thickness of 25 μm is coated out as described above.

Bonding of FPCBs with the Adhesive Tape Produced

Two FPCBs are bonded using in each case one of the adhesive tapes produced in accordance with Examples 1 and 2. For this purpose the adhesive tape is laminated onto the polyimide sheet of the polyimide/copper foil FPCB laminate at 140° C. and 170° C. Subsequently a second polyimide sheet of a further FPCB is bonded to the adhesive tape and the whole assembly is compressed in a heatable Bürkle press at 200° C. and a pressure of 1.3 MPa for one hour.

### Test Methods

The properties of the adhesive sheets produced in accordance with the examples specified above is investigated by the following test methods.

T-Peel Test with FPCB

Using a tensile testing machine from Zwick, the FPCB/adhesive tape/FPCB assemblies produced in accordance with the process described above are peeled from one another at an angle of 180° and with a rate of 50 mm/min, and the force required, in N/cm, is measured. The measurements are made at 20° C. and 50% relative humidity. Each measurement value is determined three times.

### Solder Bath Resistance

The FPCB assemblies bonded in accordance with the process described above are laid for 10 seconds onto a solder bath which is at a temperature of 288° C. The bond is rated solder bath resistant if there is no formation of air bubbles which cause the polyimide sheet of the FPCB to inflate. The test is rated as failed if there is even slight formation of bubbles.

### Water Absorbency

The pure adhesives are dried in a size of 5×5 cm in an oven at 110° C., cooled to room temperature in a desiccator containing a drying agent, and weighed. The samples are then stored in water at 23° C. for 24 h. Following removal from the water bath, the samples are dried off with cellulose and weighed again. The ratio between the difference in the two measurements and the measurement after drying indicates the amount of water which can be absorbed.

### Results:

For adhesive assessment of the abovementioned examples the T-peel test is conducted.

The results are given in Table 1.

TABLE 1
T-peel test [N/cm]

| | |
|---|---|
| Example 1 | Partial delamination of the copper/polyimide |
| | assembly at about 15 N/cm. Otherwise, values |
| | between 15 and 16 N/cm. |
| Comparative | Delamination of the copper/polyimide assembly |
| Example 2 | at about 15 N/cm. No failure of the bond with |
| | inventive adhesive tape |

Both the example and the comparative example give rise to adhesives having very high bond strengths. The bond strength is virtually unaffected by the addition of the water absorbency reducing agent.

The solder bath test is passed by all two examples. This is an indicator that the lauric acid has been incorporated into the network and has actually reacted with the epoxy resin.

Differences between the two examples are apparent in the water absorption. While the comparative example absorbs 3.6% by weight of water, the corresponding amount in the case of Example 1 is only 2.1%. This shows that it has been possible to reduce the water absorbency significantly.

1. Heat-activable adhesive tape for producing and further processing electronic components and conductor tracks, having an adhesive composed at least of
a) a polyamide having terminal amino and/or acid groups,
b) an epoxy resin,
c) a compound having an apolar chain with at least 6 carbon atoms and at least one reactive end capable of reacting with the epoxy resins,
d) optionally, a plasticizer,
the polyamide being capable of reacting with the epoxy resin at temperatures of at least 150° C., and the weight ratio of a) to b) being between 50:50 to 99:1.

2. Heat-activable adhesive tape according to claim 1, wherein the polyamide is a non-crystalline copolyamide.

3. Heat-activable adhesive tape according to claim 1 wherein the viscosity number of the polyamide, measured in accordance with ISO 307, in 96% strength sulphuric acid is 100 to 130 ml/g.

4. Heat-activable adhesive tape according to claim 1, wherein the compound c) contains at least one acid, acid anhydride, amino, alcohol, mercapto, nitrile, halogen or epoxide group.

5. Heat-activable adhesive according to claim 1, wherein the fraction of the compound containing the reactive group is between 1% and 10% by weight, based on the total mass of the adhesive.

6. Heat-activable adhesive tape according to claim 1, wherein the plasticizer is selected from the group consisting of phthalates, trimellitates, phosphoric esters, natural oils, polyalkylene oxides, rosins, polyethylene glycol and combinations thereof.

7. Heat-activable adhesive tape according to claim 1, wherein the amount of the plasticizer is between 5% by weight and 45% by weight of the total mass of the adhesive.

8. Heat-activable adhesive tape according to claim 1, wherein the adhesive tape comprises accelerators, dyes, carbon black and/or metal powders.

9. A method for bonding plastic parts which comprises bonding said parts with the adhesive tape of claim 1.

10. A method for bonding electronic components and/or flexible printed circuits (FPCBs) which comprises bonding said electronic components and/or flexible printed circuits with the adhesive tape of claim 1.

11. A method for bonding an object to polyimide which comprises bonding said object to said polyimide with the adhesive tape of claim 1.

12. The heat-activable adhesive tape of claim 2 wherein said non-crystalline copolyamide is PA 6,6/6,12 or PA 6,6/6,11
